(19) United States
(12) Patent Application Publication
(10) Pub. No.: US 2014/0181155 A1
(43) Pub. Date: Jun. 26, 2014

(54) SYSTEMS AND METHODS FOR DIRECTING IMAGED DOCUMENTS TO SPECIFIED STORAGE LOCATIONS

(71) Applicant: DROPBOX, INC., San Francisco, CA (US)

(72) Inventor: Ramsey Homsany, San Francisco, CA (US)

(73) Assignee: DROPBOX, INC., San Francisco, CA (US)

(21) Appl. No.: 13/723,734

(22) Filed: Dec. 21, 2012

(51) Int. Cl. G06F 17/30

(52) U.S. Cl. CPC G06F 17/3028
USPC 707/812

(57) ABSTRACT

Systems and methods for substantially automatically storing imaged documents in particular file storage locations. In various embodiments, the system is configured to automatically store an imaged document in a particular file storage location based, at least in part, on at least one machine-readable indicia (e.g., a bar code, such as a linear or matrix bar code) that is included within the document. In particular embodiments, the system is configured to store the documents under particular file names or as particular file types associated with the indicia. The system may also be adapted to automatically assemble multiple imaged documents into a single document based, for example, on respective page numbers that are associated with the machine-readable indicia, or that are included within the images themselves.

### BACKGROUND

Currently, storing an imaged document (e.g. a text document that has been either scanned or photo-imaged and converted to a corresponding digital data file) in a content management system may be a multi-step process that involves imaging the document to create an image data file, naming the file, and saving the file to a desired storage location within the content management system. Those wishing to store imaged documents in a particular storage location may desire to quickly and efficiently store the imaged documents in those particular storage locations. Accordingly, there is a need for improved systems and methods for directing and storing imaged documents in specified storage locations.

### SUMMARY

A computer-implemented method, according to various embodiments, may include receiving a digital file (e.g., a digital image) that includes at least one machine-readable indicium. The method may also include retrieving information including a particular file storage location associated with the at least one machine-readable indicium and determining the particular file storage location based, at least in part, on the information. Finally, the method may include storing the image in the particular file storage location.

A computer system, according to certain embodiments, may include memory and at least one processor. The processor may be configured for receiving a first image including a first machine-readable indicium and retrieving information associated with the first machine-readable indicium. In various embodiments, the information may include a particular file designator and a particular file storage location. The processor may also be configure to receive a second image including a second machine-readable indicium and retrieve information associated with the second machine-readable indicium, the information including the particular file designator. In various embodiments, the processor may be configured to use the particular file designator to determine that the first and second images should be combined into a single file and, in response to determining that the first and second images should be combined into a single file, combine the first and second images into a single file. Finally, the processor may be configured to store the single file in the particular file storage location.

### BRIEF DESCRIPTION OF THE DRAWINGS

Various embodiments of a content management system are described below. In the course of this description, reference will be made to the accompanying drawings, which are not necessarily drawn to scale, and wherein:

FIG. 1 shows a block diagram of a content management system in accordance with an embodiment of the present system;

FIG. 2 shows a schematic diagram of a computer, such as the content management server of FIG. 1, that is suitable for use in various embodiments;

FIG. 3 shows a flow chart that generally illustrates various steps executed by a document storage module that, for example, may be executed by the document storage server of FIG. 1; and

FIGS. 4-5 show exemplary images of imaged documents including various indicia that are suitable for use with various embodiments.

### DETAILED DESCRIPTION

Various embodiments now will be described more fully hereinafter with reference to the accompanying drawings. It should be understood that the invention may be embodied in many different forms and should not be construed as limited to the embodiments set forth herein. Like numbers refer to like elements throughout.

### System Overview

In various embodiments, various methods for directing imaged documents to specified storage locations may include substantially automatically (e.g., automatically) creating a digital copy of a physical document (e.g., by scanning or taking a digital image of the document), and sending that digital copy of the physical document to the specified storage location, which may be, for example: (1) a cloud-based content management system; (2) a particular folder on a storage device associated with a user; (3) an e-mail account associated with a particular person; and/or (4) any other suitable location. In particular embodiments, a user may place a machine-readable indicium (e.g., a bar code, such as a QR code or similar code, or other suitable machine-readable indicium) that contains storage location information on the physical document. The user may then image the physical document (e.g., by scanning the document, taking a digital photograph of the document, or using any other suitable method of capturing an image of the document) that includes the machine-readable indicium. In particular embodiments, the content management system may then automatically send a copy of the image of the physical document to the storage location determined by the machine-readable indicia.

For example, the content management system may associate a particular machine-readable indicium with a particular location to which to send an image of the physical document. The machine-readable indicium may be selected, for example: (1) to provide the particular location when read by a suitable computer; or (2) to provide a code that corresponds to the particular location when read by a suitable computer. As noted above, the particular location may be any suitable location for storing digital images or other files.

In particular embodiments, the machine-readable indicium may include, or may be used to determine, further information for storing the imaged document, such as a particular folder or subfolder within the storage location in which to store the copy of the image of the physical document. For example, a user may place a QR code on a copy of their birth certificate (e.g., by affixing the QR code to their birth certificate) that contains instructions to store the document containing that QR code in a folder called “Important Documents” in the user's cloud-based file storage account. The user may then take a picture of their birth certificate with the affixed QR code with their mobile device (e.g., smart phone). The content management system may then retrieve storage location information from the QR code and store the image of the birth certificate in the user's cloud-based file storage system in the folder named “Important Documents.”

### Exemplary Technical Platforms

The present invention may be, for example, embodied as a computer system, a method, or a computer program product. Accordingly, various embodiments may be entirely hardware, entirely software, or a combination of hardware and software. Furthermore, particular embodiments may take the form of a computer program product stored on a computer-readable storage medium having computer-readable instructions (e.g., software) embodied in the storage medium. Various embodiments may also take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatus (e.g., systems), and computer program products. It should be understood that each element of the block diagrams and flowchart illustrations, and combinations of elements in the block diagrams and flowchart illustrations, respectively, can be implemented by a computer executing computer program instructions. These computer program instructions may be loaded onto a general purpose computer, a special purpose computer, smart mobile device, or other programmable data processing apparatus to produce a machine. As such, the instructions which execute on the general purpose computer, special purpose computer, smart mobile device, or other programmable data processing apparatus create means for implementing the functions specified in the flowchart block or blocks. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, block diagram elements and flowchart illustrations support combinations of mechanisms for performing the specified functions, combinations of steps for performing the specified functions, and program instructions for performing the specified functions. It should also be understood that each block diagram element and flowchart illustration, and combinations of block diagram elements and flowchart illustrations, can be implemented by special purpose hardware-based computer systems that perform the specified functions or steps, or combinations of special purpose hardware and other hardware executing appropriate computer instructions.

### Example System Architecture

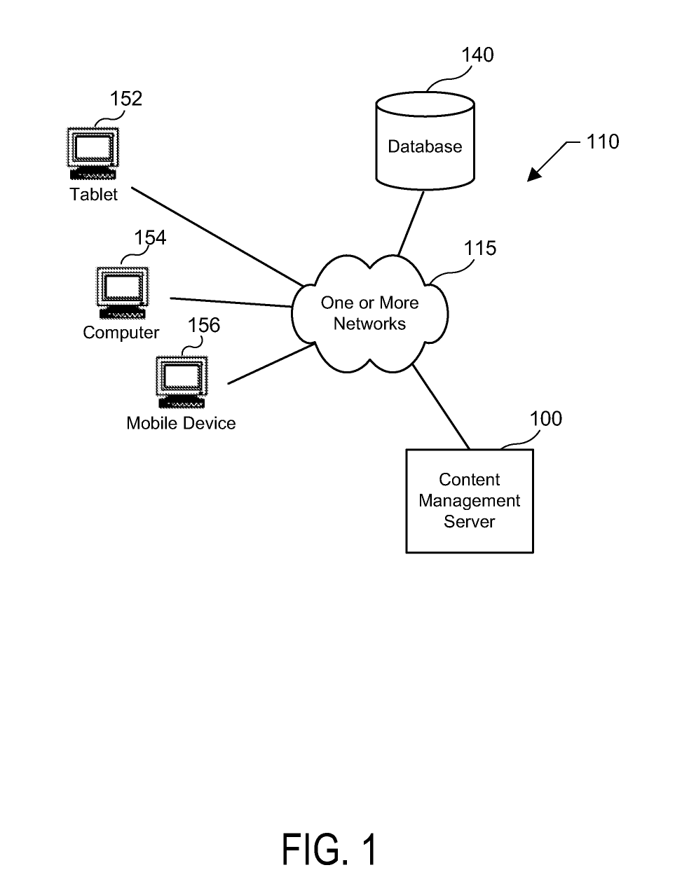

FIG. 1 is a block diagram of content management system 110 according to a particular embodiment. As may be understood from this figure, content management system 110 includes remote computing devices such as tablet computer 152, desktop or laptop computer 154, or mobile device 156 (e.g., a handheld device, a laptop, a tablet computer, a cellular phone, a smart phone, or any other device capable of transferring files over network 115) that are in communication with content management server 100 (which, for example, may be used to execute one or more modules as described below) and content management database 140 (which, for example, may be used to store the files on the content management system) via one or more networks 115. Network 115 between content management server 100 and remote computing devices 152, 154, 156 may be, for example, implemented via one or more wired or wireless networks such as LANs, WANs, a cellular network, a Wi-Fi network, or via the Internet. For purposes of ease of explanation and clarity, no specific network is shown in FIG. 1. The users of each of tablet computer 152, desktop computer 154, and mobile device 156 may have file storage accounts on content management server 100.

In various embodiments, content management server 100 may include one or more servers that are located in close physical proximity, or some servers may be locally together and others remote. In either case, all devices, wherever located, function as a system.

Content management server 100 may enable file access and file storage between content management server 100 and remote computing devices 152, 154, 156. Content management server 100 may receive files from and send files to remote computing devices 152, 154, 156 consistent with the user's preferences for sharing files. Content management server 100 may act as the counterpart to a client-side file storage service client application user interface that allows a user to manipulate files directly stored on content management server 100. In some embodiments, software operating on remote computing devices 152, 154, 156 may integrate network-stored files with the client's local file system to enable a user to manipulate network-stored files through the same user interface (UI) used to manipulate files on the local file system, e.g., via a file explorer, file finder, or browser application. As an alternative or supplement to the client-side file explorer interface, content management server 100 may provide a web interface for remote computing devices 152, 154, 156 to access (e.g. via a web browser) and allow a user to manipulate files stored on content management server 100. In this way, the user can directly manipulate files stored on content management server 100.

In various embodiments, content management database 140 may store files such as those uploaded using remote computing devices 152, 154, 156. It should be understood that, in various embodiments, content management database 140 may include of multiple data stores—some local to, and some remote from, content management server 100.

Content management database 140 may maintain, for each user, information identifying the user, information describing the user's file directory, etc. in a file journal that is maintained for each user. In some embodiments, the file journal may be maintained on content management server 100. This file journal may be updated periodically using information obtained directly from content management server 100 and/or from information obtained from one or more remote computing devices 152, 154, 156. In this way, the server-stored file journal on content management server 100 (hereinafter the “server-side file journal”) may be updated when a file is changed on the server or on the local client. Content management server 100 then may communicate with one or more remote computing devices 152, 154, 156 to assure that any relevant changes are reflected locally. For example, if a user makes a change to a particular file on a first client device, the change may be reflected in the server-side file journal. The system may then use the server-side file journal to propagate the changes to the file to all client devices associated with the file. Such techniques may be implemented, for example, within the context of a synchronized file system such as the Dropbox™ Service of Dropbox, Inc. of San Francisco, Calif.

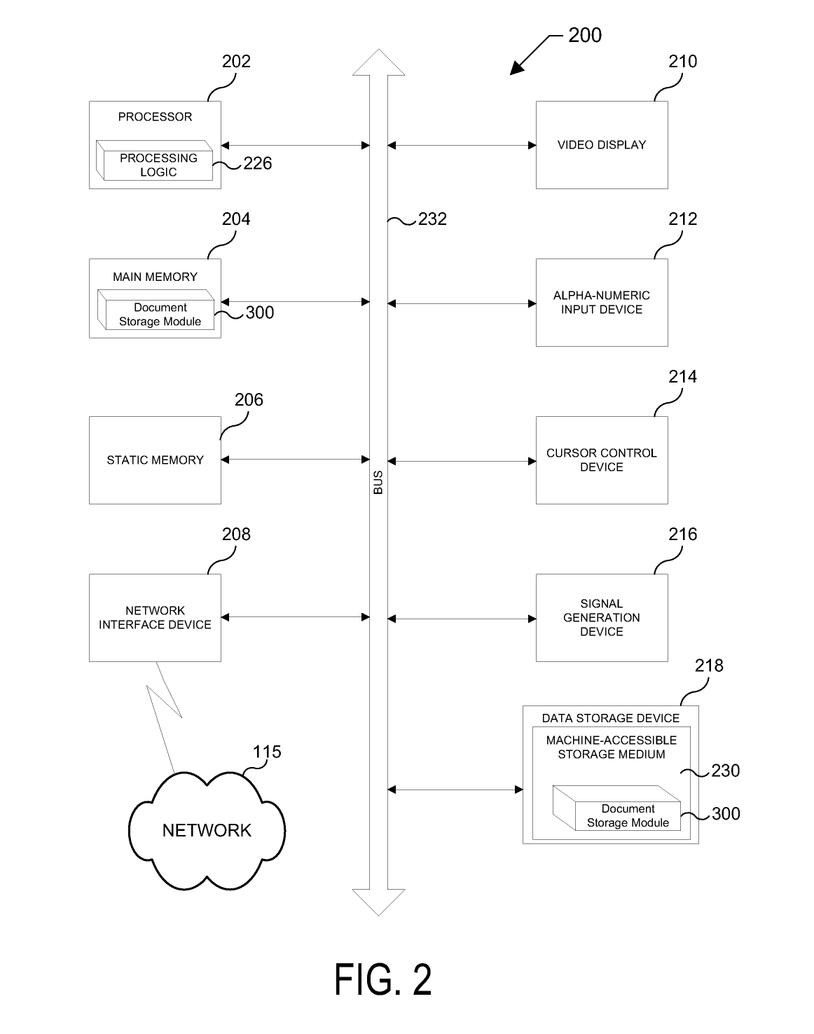

FIG. 2 illustrates a diagrammatic representation of computer 200 that can be used within system 100, for example, as content management server 100, or as a client computer 152, 154, 156 (FIG. 1). For purposes of this disclosure, reference to a server or processor, should be interpreted to include either a single server, a single processor, or multiple servers, or multiple processors.

In particular embodiments, computer 200 may be connected (e.g., networked) to other computers by a WAN, LAN, an intranet, an extranet, and/or the Internet. Computer 200 may operate in the capacity of a server or a client computer in a client-server network environment, or as a peer computer in a peer-to-peer (or distributed) network environment. Computer 200 may be personal computer (PC), tablet PC, mobile device, a web appliance, a server, a network router, a switch or bridge, or any computer capable of executing a set of instructions (sequential or otherwise) that specify actions to be taken by that computer. Further, while only a single computer is illustrated, the term “computer” may also include any collection of computers that individually or jointly execute a set (or multiple sets) of instructions to perform any one or more of the methodologies discussed herein.

Exemplary computer 200 may include processor 202, main memory 204 (e.g., read-only memory (ROM), flash memory, dynamic random access memory (DRAM) such as synchronous DRAM (SDRAM) or Rambus DRAM (RDRAM), etc.), static memory 206 (e.g., flash memory, static random access memory (SRAM), etc.), and data storage device 218, which communicate with each other via bus 232.

Processor 202 may represent one or more general-purpose processing devices such as a microprocessor, a central processing unit, or the like. More particularly, the processing device may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 202 may also be one or more special-purpose processing devices such as an application specific integrated circuit (ASIC), a field programmable gate array (FPGA), a digital signal processor (DSP), a network processor, or the like. Processor 202 may be configured to execute processing logic 226 for performing various operations and steps discussed herein.

Computer 200 may further include a network interface device 208. Computer 200 also may include video display 210 (e.g., a liquid crystal display (LCD) or a cathode ray tube (CRT)), alpha-numeric input device 212 (e.g., a keyboard), cursor control device 214 (e.g., a mouse), and signal generation device 216 (e.g., a speaker).

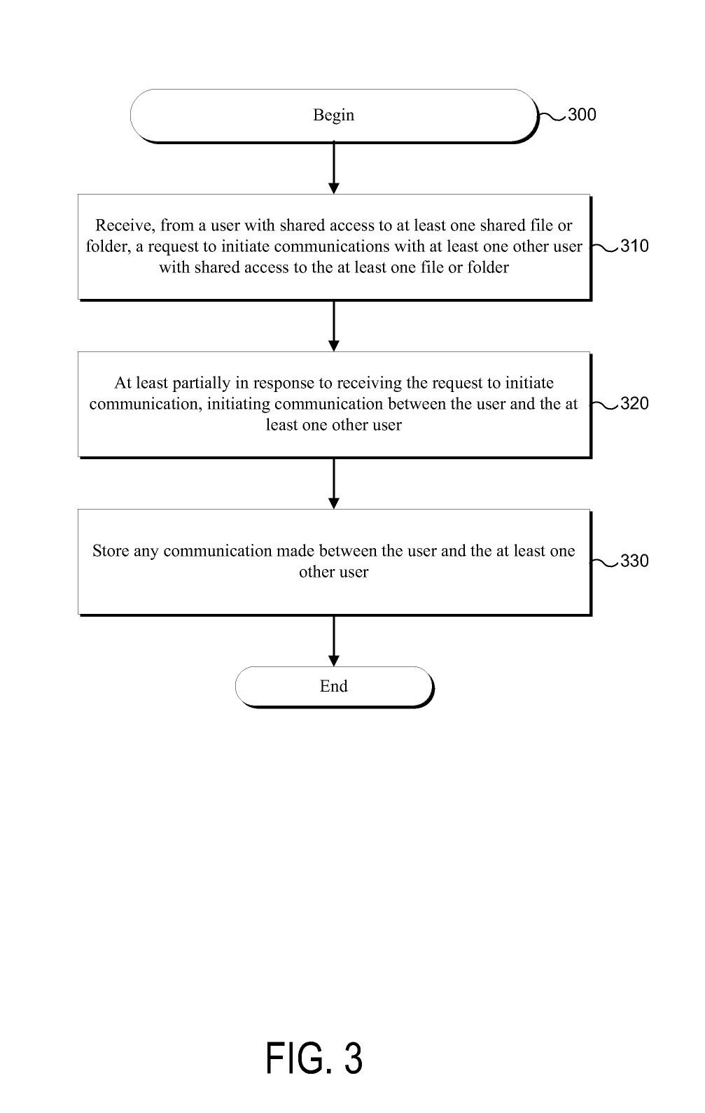

Data storage device 218 may include machine accessible storage medium 230 (also known as a non-transitory computer-accessible storage medium, a non-transitory computer-readable storage medium, or a non-transitory computer-readable medium) on which is stored one or more sets of instructions (e.g., Document Storage Module 300 illustrated in FIG. 3) embodying any one or more of the methodologies or functions described herein. Document Storage Module 300 may also reside, completely or at least partially, within main memory 204 and/or within processing device 202 during execution thereof by computer 200, main memory 204, and processing device 202 also constituting computer-accessible storage media. Instructions (e.g., Document Storage Module 300) may further be transmitted or received over network 115 via network interface device 208.

While machine-accessible storage medium 230 is shown in an exemplary embodiment to be a single medium, the term “machine-accessible storage medium” should be understood to include a single medium or multiple media (e.g., a centralized or distributed database, and/or associated caches and servers) that store the one or more sets of instructions. The term “machine-accessible storage medium” should also be understood to include any medium that is capable of storing, encoding, or carrying a set of instructions for execution by the computer and that cause the computer to perform any one or more of the methodologies of the present invention. The term “computer-accessible storage medium” should accordingly be understood to include, but not be limited to, solid-state memories, optical, and magnetic media.

### Exemplary System Platform

Various embodiments of a system for directing imaged documents to specified storage locations may be implemented within the context of any suitable content management service (e.g., a synched content management service). In other embodiments, the system may be implemented in the context of a local file storage system (e.g., on any device capable of storing files such as a laptop, personal computer, tablet, server, or other suitable, local file storage system). In other embodiments, the system is implemented within the context of any other suitable system capable of storing files (e.g., any file storage system).

Various aspects of the system's functionality may be executed by certain system modules, including Document Storage Module 300. This module is discussed in greater detail below.

Document Storage Module

FIG. 3 shows a flow chart of operations performed by an exemplary Document Storage Module 300. In particular embodiments, Document Storage Module 300 may facilitate the storage of imaged documents in particular file storage locations that may be based on one or more indicia that are included on or near the imaged documents.

When executed by the content management system, the Document Storage Module begins at Step 310 by receiving from any suitable source, such as an imaging device, a computer-readable data file representing an image of a document that includes one or more indicia (e.g., machine-readable indicia). In particular embodiments, the system may be configured to receive the image file at the direction of a user, who, for example, may select the image file from one or more existing image files stored on a storage device associated with the user (e.g., the user's smart phone). In such embodiments, the existing image files may have been created at an earlier time (e.g., by the user's smart phone), or may have been created by a different device (e.g., a digital camera) and sent to a storage device associated with the user (e.g., via e-mail).

In certain embodiments, the user may install a suitable application on their portable device that is adapted to: (1) enable capturing an image of a particular document using a camera associated with the mobile device to create an image file; (2) read from the image a machine-readable indicium associated with the particular document to determine information associated with the document (e.g., a file designator such as a name of the document, a location where the document is to be stored, or a file type for the stored document); and (3) use the information to save the image file as a correct file type, in a correct location, under the correct filename. In various embodiments, the application may be adapted to execute one or more of these steps each time the user takes a new picture of a document that includes an appropriate machine-readable indicium.

In certain embodiments, the application may be further adapted to display an error message if either: (1) the image does not include a document; or (2) the image does not include an appropriate machine-readable indicium. In other embodiments, in such situations, the application may not display such an error message and may simply save the image to a default photo storage location on the mobile device, such as the mobile device's photo gallery. This may, for example, allow a user to conveniently alternate between: (1) imaging and storing documents, and (2) taking photos of other types of objects.

As will be understood in light of this disclosure, the system may be used to image and store any suitable type of document. Such documents may include, for example, photographs, printed documents, handwritten notes, receipts, invoices, and/or any other suitable type of document. The system may also be used to store images of objects other than documents.

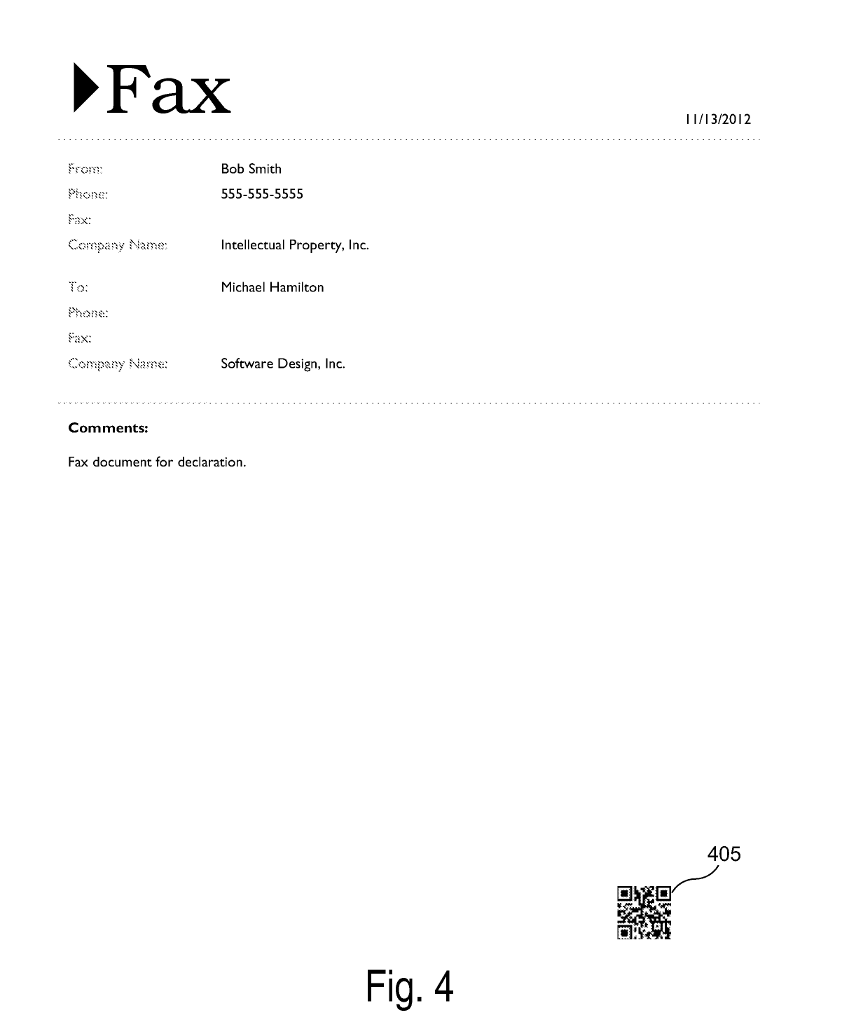

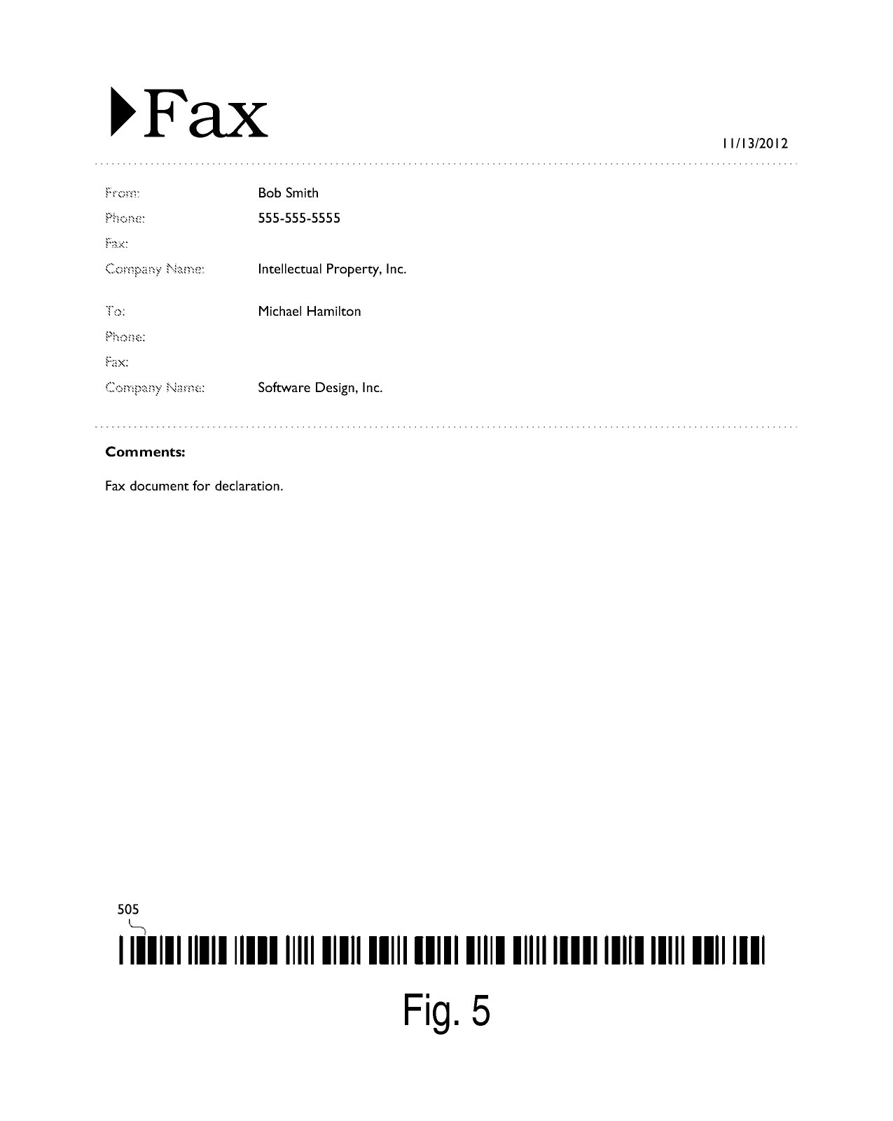

In particular embodiments, the one or more machine-readable indicia that the image includes may be substantially integrated (e.g., integrated) into the document that is contained in the image. As a particular example, a fax document for inclusion in a client file may include a machine-readable indicium within the document. FIG. 4, for example, shows a fax document including QR code 405 within the physical document. As may be understood from this figure, QR code 405 was included in the original fax document when the document was created (e.g., when the document was originally drafted and printed, and before an image of the document was received by the system at Step 310). An alternative embodiment of an image of a document with an embedded indicium is shown in FIG. 5. As shown in this figure, imaged documents, in various embodiments, may include one or more embedded bar codes 505. In various embodiments, documents may include any suitable indicium such as, for example, a QR code, a barcode, a serial number, or any other suitable indicium.

In particular embodiments, the one or more indicia that the image includes may be manually applied to the document prior to imaging. For example, the user may be able to apply a bar code, or similar indicia to a document that does not contain an indicium before creating the image of the document that the system receives at Step 310. In a particular example, a user may affix an indicium to a document prior to imaging by placing a sticker bearing the one or more indicia on the document, stamping the one or more indicia on the document, placing one or more indicia on or adjacent the document, or otherwise positioning (e.g., permanently or temporarily) one or more indicia in any suitable manner such that when the document is imaged, the resulting image includes the one or more indicia.

Returning to FIG. 3, the system continues, at Step 320, by retrieving information associated with the one or more indicia. The system may do this, for example, by: (1) reading the indicia; or (2) reading the indicia to derive a code, and then using the code to retrieve the information from a suitable database. In particular embodiments, the information may include particular file storage location information, which may include, for example, a particular folder in which to store the image received at Step 310. In various embodiments, the particular file storage location information may include, for example, a file storage location in: (1) a cloud-based file storage system, (2) a particular folder on a storage device associated with a user, or (3) any other suitable location (e.g., in any file storage system). In particular embodiments, the particular file storage location information may include a particular folder associated with a user's account in a cloud-based synchronized content management service, such as the Dropbox™ Service.

In various embodiments, the information associated with the one or more indicia may include account information for the user's account in the cloud-based content management service (e.g., a user's account name, password, and other identifying information). The information associated with the one or more indicia may also include, for example: (1) a target file name (e.g., a file name under which to store the image received at Step 310, such as “Birth_Certificate.PDF”); and/or (2) a file type in which the image received at Step 310 should be stored.

The system continues, at Step 330, by, substantially automatically (e.g., automatically) storing the image in the particular file storage location based at least in part on the information. In various embodiments, the system may be configured to store the image in any suitable file format (e.g., PDF, JPEG, BMP, etc.). In embodiments in which the information includes account information for a user's cloud-based content management service, along with a destination directory associated with the user's account, the system may be configured to substantially automatically (e.g., automatically) enter login information associated with the user account in order to store the imaged document in the particular storage location substantially seamlessly (e.g., without requiring the user to login to their cloud-based content management account or otherwise perform any other action than selecting or otherwise providing the imaged document to the system). In various embodiments, the system may be configured to store the imaged document in the particular file storage location under a particular file name, which may, for example, have been retrieved at Step 320 as information associated with the one or more indicia.

### First Illustrative Example

In a particular example of a system for directing imaged documents to a particular storage location, a law firm may utilize the system to substantially automatically (e.g., automatically) store signed documents and associated printed communications that the law firm receives from clients in a particular folder associated with the client within the firm's content management system. For example, a patent firm may ask inventors on patent applications to sign particular forms for inclusion with the filing of a patent application (e.g., declaration forms, assignment documents, etc.). The patent firm may wish to store copies of these signed forms and the other physical communications (such as faxes) for the firm's records or for any other reason. When creating such forms, such as a fax document, the firm may incorporate an indicium such as a bar code into the document. The indicium may be associated with the particular client for whom the fax document was prepared and may further be associated with a particular folder in the firm's content management system that is associated with the client. Additionally, the indicium may be associated with a particular file name under which the firm would like the declaration document to be stored (e.g., “Signed_Declaration_Fax.pdf”).

As may be understood from this example, the printed copy of the fax document would include the indicia described above. Once the firm receives the signed copy of the fax document from the inventor, a user at the firm may image the document (e.g., using a scanner or a suitable mobile device such as a smart phone). The user may then send the imaged fax document to the system, which, at Step 310, receives the image of the signed fax document. The system then, at Step 320, retrieves information associated with the indicium in the scanned image. In this case, the system retrieves information associated with the desired file name for the signed fax document (e.g., “Signed_Declaration_Fax.pdf”) as well as information about the particular file storage location associated with the client and the desired file type for the image. The system continues, at Step 330, by storing the image of the signed fax document in accordance with the information that was associated with the indicium. In this case, the system substantially automatically (e.g., automatically) stores the image of the signed fax document as a file called “Signed_Declaration.pdf” in the folder associated with the particular client (e.g., the inventor) within the firm's content management system.

### Second Illustrative Example

In a second illustrative example of a system for directing imaged documents to a particular storage location, a user of the system may desire to store digital copies of one or more photographs of which the user possesses physical copies. The user may wish to store all of the digital copies of the photographs in particular folders within their cloud-based file storage account. The user may create indicia such as QR codes that are associated with the various folders in their cloud-based file storage account in which the user would like to store the various digital copies of the photographs. For example, if the user has photographs from two events—a wedding and a baptism—the user may create two indicia. The first indicium may be an indicium associated with a folder on the user's cloud-based file storage account called “Wedding Photos”, and the second indicium may be an indicium associated with a folder on the user's cloud-based file storage account called “Baptism Photos”. The user may further associate other information with both indicia, such as the username and password to the user's cloud-based file storage account.

The user may then image the photographs (e.g., one at a time) using any suitable imaging technique (e.g., scanning the photographs, taking an image of the photographs with a mobile device, etc.), while being sure to take the image so that the correct indicium (e.g., the indicium associated with the event at which each individual photograph was taken) is included within the image along with the photograph. As the system receives the imaged photographs, the system retrieves information about the imaged photograph from the included indicium (e.g., the desired destination folder for the imaged photograph) and substantially automatically (e.g., automatically) uploads the imaged photograph to the proper folder in the user's cloud-based file storage account.

### Alternative Embodiments

Substantially Automatic Removal of Indicia from Stored Image

In particular embodiments, the system may be adapted to substantially automatically (e.g., automatically) remove any indicia from an imaged document prior to storing the imaged document in the particular storage location associated with the indicia. In various embodiments, the system may remove the indicia in any suitable manner (e.g., by cropping the indicia from the imaged document, electronically removing the indicia from the imaged document, etc.). In particular embodiments, the removal of the indicia may result in a clean version of the stored document that is free of extraneous indicia (e.g., indicia that are no longer necessary in a document that has already been stored in the location associated with the indicia).

Multi-Page Document

In particular embodiments, the system may be configured to compile a plurality of images that form a single document into a single document (e.g., file) before storing the document in the particular file storage location associated with the indicia that the various images that make up the pages of the documents include. For example, in particular embodiments, each page of a ten page document (e.g., a legal memorandum, a lease, or any other document) may include an indicium with associated information that includes the name of the document and a page number of the particular page within the document. In such an example, when the system receives each image of each page of the ten page document, the system may compile all ten pages into the full document (e.g., in order by page number) before storing the file in the particular storage location associated with the indicia. In such embodiments, the system may compile the images into the full document (e.g., the full ten page document with the pages in order) even if the images of the document are received and/or taken out of order (e.g., in an order other than the order in which each individual page appears in the full document). The system may do this, for example, by ordering the pages in sequential order based, at least in part, on the respective page numbers that are determined based on the indicia associated with the respective image of each page of the document.

In other embodiments, the system may be adapted to determine an appropriate order of images of a series of pages of a single document by: (1) using Optical Character Recognition (“OCR”) techniques to read the page number of the document within each respective image; and (2) determining the order of the images based on the page numbers. For example, as in the example discussed above, the system may order the images in sequential order based on the respective page numbers.

Pre-Image Storage Security Checks

In other embodiments, the system may be configured to retrieve information associated with the one or more indicia that include account information for accounts for which the system is authorized to store the computer readable image data file in the particular file storage location. For example, when creating the one or more indicia, users may provide account information for users for whom the system is authorized to store the computer readable image data file in the particular file storage location. In such embodiments, the system, in response to receiving a computer readable image data file representing a document and comprising one or more indicia from a user whose user account was not authorized for automatic storage, would not store the computer readable image data file in the particular file storage location associated with the one or more indicia.

In various other embodiments, the system may be configured to determine whether the system should store the computer readable image data file in the particular file location based on information other than account information associated with the user who has imaged the document. For example, the system may be configured to not store the computer readable image data file in the particular storage location based on any of the following factors: (1) the system receives the computer readable image data file from a location other than a location authorized by information associated with the one or more indicia (e.g., a geographic location such as a country, city, or physical location associated with a particular company or business); (2) the system receives the computer readable image data file from a device other than a device that is authorized by the information associated with the one or more indicia; etc.

### CONCLUSION

Many modifications and other embodiments of the invention will come to mind to one skilled in the art to which this invention pertains having the benefit of the teachings presented in the foregoing descriptions and the associated drawings. While examples discussed above cover the use of the invention in the context a content management service, the invention may be used in any other suitable context. Also, while various examples are described above as being applied to files and folders, it should be understood that the same or similar techniques may be applied to types of digital content other than files or folders, such as a post on a social media web site that is not stored in the form of a file, progress made in a video game where the progress is not saved as part of a file, or the appearance of an avatar that is not stored in the form of a file. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

We claim:

1. A computer-implemented method comprising:
receiving, by a processor, a computer-readable image data file comprising at least one machine-readable indicium;
retrieving, by a processor, particular file storage location information associated with the at least one machine-readable indicium;
determining, by a processor, the particular file storage location from the information; and
storing, by a processor, the image in the particular file storage location.

2. The method of claim 1, further comprising:
reading, by a processor, the at least one machine-readable indicium to determine a code; and
using, by a processor, the code to retrieve the information from a database.

3. The method of claim 1, further comprising reading by a processor the at least one machine-readable indicium to determine the information.

4. The method of claim 1, wherein:
the information associated with the at least one machine-readable indicium comprises a particular file name; and
the storing the image in the particular file storage location comprises storing the image under the particular file name.

5. The method of claim 1, wherein:
the information associated with the at least one machine-readable indicium comprises a file type; and
the storing the image in the particular file storage location comprises storing the image as the particular file type.

6. The method of claim 1, wherein the information associated with the at least one machine-readable indicium comprises user account information, the user account information being associated with the particular file storage location; and
the storing the image in the particular file storage location comprises providing the user account information to access the particular file storage location.

7. The method of claim 6, wherein the user account information comprises a username and password.

8. The method of claim 1, wherein the at least one machine-readable indicium comprises a bar code.

9. The method of claim 1, wherein the particular file storage location is a file system associated with a user account in a synched, cloud-based content management system.

10. The method of claim 9, wherein the particular file storage location is a particular folder within the file system.

11. The method of claim 1, wherein the image is an image of a physical document.

12. The method of claim 1, wherein:
the image is a first image;
the at least one machine-readable indicium is a first at least one machine-readable indicium;
the information comprises a particular file designator; and
the method further comprises:
receiving a second image comprising a second at least one machine-readable indicium;
retrieving information associated with the second at least one machine-readable indicium, the information comprising the particular file designator;
using the particular file designator to determine that the first and second images should be combined into a single file;
in response to determining that the first and second images should be combined into a single file, combining the first and second images into a single file; and
storing the single file in the particular file storage location.

13. The method of claim 12, wherein:
the first image comprises a first page of a document;
a first page number is printed on the first page of the document;
the second image comprises a second page of the document;
a second page number is printed on the second page of the document; and
the method further comprises:
reading the first and second page numbers; and
using the first and second page numbers to determine an order in which the first and second images should be included in the single file; and
arranging the first and second images in the order within the single file.

14. The method of claim 13, wherein the step of reading the first and second page numbers comprises using optical character recognition techniques to read the first and second page numbers.

15. The method of claim 1, wherein the method further comprises removing the at least one indicia from the image.

16. One or more non-transitory computer-readable media encoding one or more processor-executable instructions, wherein the one or more processor-executable instructions, when executed by a processor, cause acts to be performed comprising:
receiving a computer-readable image data file representing an image of a document, the image comprising one or more indicia;
retrieving file storage information associated with the one or more indicia; and
storing the image based on the file storage information.

17. The one or more non-transitory computer-readable media encoding one or more processor-executable instructions of claim 16, wherein:
the information associated with the one or more indicia comprises a particular file storage location; and
the storing the image comprises storing the image in the particular file storage location.

18. The one or more non-transitory computer-readable media encoding one or more processor-executable instructions of claim 17, wherein:
the information associated with the one or more indicia comprises a particular file name; and
the storing the image further comprises storing the image under the particular file name.

19. The one or more non-transitory computer-readable media encoding one or more processor-executable instructions of claim 17, wherein:
the information associated with the one or more indicia comprises a file type; and
the storing the image further comprises storing the image in the particular file type.

20. The one or more non-transitory computer-readable media encoding one or more processor-executable instructions of claim 16, wherein the one or more indicia are selected from a group consisting of:
(a) a matrix barcode; and
(b) a linear barcode.

21. The one or more non-transitory computer-readable media encoding one or more processor-executable instructions of claim 16, wherein the particular file storage location is a particular folder associated with a user account in a cloud-based file storage system.

22. The one or more non-transitory computer-readable media encoding one or more processor-executable instructions of claim 16, wherein the image is an image of a physical document.

23. A computer system comprising:
memory; and
at least one processor, wherein the computer system is configured for:
receiving a first computer-readable image data file comprising a first machine-readable indicium;
retrieving information associated with the first machine-readable indicium, the information comprising a particular file designator and a particular file storage location;
receiving a second computer-readable image data file comprising a second machine-readable indicium;
retrieving information associated with the second machine-readable indicium, the information comprising the particular file designator;
using the particular file designator to determine that the first and second image data files should be combined into a single file;
in response to determining that the first and second image files should be combined into a single file, combining the first and second image files into a single file; and
storing the single file in the particular file storage location.

24. The system of claim 23, wherein the system is a synchronized content management system.

25. The system of claim 23, wherein:
the first image comprises a first page of a document;
a first page number is printed on the first page of the document;
the second image comprises a second page of the document;
a second page number is printed on the second page of the document; and
the system is further configured for:
reading the first and second page numbers; and
using the first and second page numbers to determine an order in which the first and second images should be included in the single file; and
arranging the first and second images in the order within the single file.

26. The system of claim 25, wherein the step of reading the first and second page numbers comprises using optical character recognition techniques to read the first and second page numbers.

27. A computer-implemented method comprising:
receiving, by a processor, computer-readable digital content comprising at least one machine-readable indicium;
retrieving, by a processor, digital content storage location information associated with the at least one machine-readable indicium;
determining, by a processor, a particular digital content storage location from the information; and
storing, by a processor, the digital content in the particular digital content storage location.

28. The method of claim 27, further comprising:
reading, by a processor, the at least one machine-readable indicium to determine a code; and
using, by a processor, the code to retrieve the digital content storage location information from a database.
